(19) United States
(12) Patent Application Publication
(10) Pub. No.: US 2019/0360695 A1
(43) Pub. Date: Nov. 28, 2019

(54) Rotating Detonation Combustion System

(71) Applicant: General Electric Company, Schenectady, NY (US)

(72) Inventors: Arthur Wesley Johnson, Cincinnati, OH (US); Steven Clayton Vise, Loveland, OH (US); Clayton Stuart Cooper, Loveland, OH (US); Joseph Zelina, Waynesville, OH (US); Sibtosh Pal, Mason, OH (US)

(21) Appl. No.: 15/987,311

(22) Filed: May 23, 2018

(51) Int. Cl. F23R 3/04; F23R 7/00; F23R 3/46

(52) U.S. Cl. CPC F23R 3/04; F02K 7/10; F23R 3/46; F23R 7/00

(57) ABSTRACT

A rotating detonation combustion (RDC) system including a gas nozzle defining a first convergent-divergent nozzle providing a flow of gas at least partially along a longitudinal direction. The flow of gas defines a fluid wall defined at least partially along the longitudinal direction. A detonation chamber is defined radially inward of the fluid wall relative to a combustion center plane. A fuel-oxidizer nozzle defining a second convergent-divergent nozzle provides a flow of fuel-oxidizer mixture to the detonation chamber. The fuel-oxidizer nozzle is defined radially inward of the gas nozzle and upstream of the detonation chamber relative to the combustion center plane.

### FIELD

The present subject matter is related to continuous detonation systems for heat engines.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/oxidizer mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine.

Although detonation combustors may generally provide improved efficiency and performance over deflagrative combustion systems, the higher heat flux and pressure gain of detonation combustors currently defines such systems at risk of lower durability in contrast to conventional deflagrative combustors. Furthermore, detonation combustors are generally limited in operating condition due to detonation cell widths restricted by finite detonation chamber geometry.

As such, there is a need for detonation combustion systems that may improve engine and rotating detonation combustion (RDC) system durability and operability.

### BRIEF DESCRIPTION

Aspects and advantages of the invention will be set forth in part in the following description, or may be obvious from the description, or may be learned through practice of the invention.

Aspects of the present disclosure are directed to a heat engine including a rotating detonation combustion (RDC) system. The RDC system includes a gas nozzle defining a first convergent-divergent nozzle providing a flow of gas at least partially along a longitudinal direction. The flow of gas defines a fluid wall defined at least partially along the longitudinal direction. A detonation chamber is defined radially inward of the fluid wall relative to a combustion center plane. A fuel-oxidizer nozzle defining a second convergent-divergent nozzle provides a flow of fuel-oxidizer mixture to the detonation chamber. The fuel-oxidizer nozzle is defined radially inward of the gas nozzle and upstream of the detonation chamber relative to the combustion center plane.

In one embodiment, the flow of gas provided by the gas nozzle defines a flow of inert gas along the longitudinal direction defining the detonation chamber.

In another embodiment, the gas nozzle is defined annularly around the combustion center plane.

In yet another embodiment, the fuel-oxidizer nozzle is defined annularly around the combustion center plane.

In still another embodiment, the RDC system includes a plurality of the fuel-oxidizer nozzles disposed in an adjacent arrangement around a circumferential direction around the combustion center plane.

In still yet another embodiment, the RDC system includes a plurality of the gas nozzle disposed in an adjacent arrangement around a circumferential direction around the combustion center plane.

In one embodiment, the RDC system includes a first gas nozzle defined upstream of the detonation chamber providing a first flow of gas at least partially along a first direction; and an opposing first gas nozzle defined downstream of the first gas nozzle providing an opposing first flow of gas along a second direction at least partially along the longitudinal direction opposite of the first direction.

In various embodiments, the RDC system includes a first gas nozzle providing a first flow of gas at least partially along the longitudinal direction at a first radius from the combustion center plane to define a first fluid wall; and a second gas nozzle providing a second flow of gas at least partially along the longitudinal direction at a second radius from the combustion center plane different from the first radius to define a second fluid wall. In one embodiment, the first gas nozzle is defined at the first radius and the second gas nozzle is defined at the second radius. Each of the first gas nozzle and the second gas nozzle are defined radially outward of the fuel-oxidizer nozzle relative to the combustion center plane. In another embodiment, the first fluid wall defines a first radius of the detonation chamber and the second fluid wall defines a second radius of the detonation chamber different from the first radius.

Another aspect of the present disclosure is directed to a method for operating an RDC system. The method includes flowing a gas at least partially along a longitudinal direction to define a fluid wall along the longitudinal direction; flowing a fuel-oxidizer mixture along the longitudinal direction radially inward of the fluid wall into the detonation chamber relative to a combustion center plane; and igniting the fuel-oxidizer mixture at the detonation chamber to produce a detonation wave radially inward of the fluid wall relative to the combustion center plane.

In various embodiments, flowing the gas is along a detonation chamber wall within the detonation chamber. In one embodiment, flowing the gas at least partially along the longitudinal direction further includes flowing the gas from a convergent-divergent nozzle upstream of the detonation chamber along a first direction at least partially along the longitudinal direction. In another embodiment, flowing the gas at least partially along the longitudinal direction further includes flowing the gas from a convergent-divergent nozzle downstream of the detonation chamber along a second direction at least partially along the longitudinal direction opposite of the first direction.

In various embodiments, the method further includes modulating a radius of the detonation chamber via the flow of gas at a first radius or a second radius. In one embodiment, modulating the radius via the flow of gas includes selectively directing the flow of gas between a first gas nozzle at the first radius and a second gas nozzle at the second radius.

In still various embodiments, flowing a gas at least partially along a longitudinal direction to define a fluid wall further includes flowing the gas at least partially along the longitudinal direction at a first radius from the combustion center plane to produce a first fluid wall; and flowing the gas at least partially along the longitudinal direction at a second radius from the combustion center plane different from the first radius to produce a second fluid wall.

In still yet various embodiments, flowing the gas to generate the first fluid wall is at one or more of a first engine condition, and flowing the gas to generate the second fluid wall is at one or more of a second engine condition different from the first engine condition. In one embodiment, each engine condition defines one or more of a pressure, temperature, or flow rate of gas upstream of the detonation chamber, or one or more of a pressure, temperature, or flow rate of fuel upstream of the detonation chamber, or combinations thereof. In another embodiment, flowing the gas at the first radius to produce the first fluid wall defines a first radius of the detonation chamber different from flowing the gas at the second radius to produce the second fluid wall defining a second radius of the detonation chamber different from the first radius.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic embodiment of a heat engine including a rotation detonation combustion (RDC) system according to an aspect of the present disclosure;

FIGS. 2-5 are cross sectional views of exemplary embodiments of the RDC system of FIG. 1; and

FIGS. 6-8 are cross sectional views of exemplary embodiments of the RDC system generally provided in FIGS. 2-5;

FIG. 9 is an exemplary embodiment of a detonation chamber of a rotating detonation combustion system generally in accordance with an embodiment of the present disclosure generally provided in FIGS. 1-8; and

FIG. 10 is a flowchart outlining exemplary steps of a method for operating a RDC system such as shown and described in regard to FIGS. 1-9.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a heat engine or vehicle, and refer to the normal operational attitude of the heat engine or vehicle. For example, with regard to a heat engine, forward refers to a position closer to a heat engine inlet and aft refers to a position closer to a heat engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. Furthermore, “upstream end 99” and “downstream end 98” are each provided generally for reference purposes, such as to clarify from which direction or to which direction a fluid flows, or arrangements of structures or elements described herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of a heat engine 10 including a rotating detonation combustion (RDC) system are generally provided. The embodiments shown and described herein may improve engine and RDC system operability via adjusting or modulating a detonation chamber via a fluid wall. The fluid wall defining the detonation chamber may improve RDC system 100 and engine 10 durability via mitigating structural deterioration at a detonation chamber wall. The fluid wall at the detonation chamber may further provide improved engine operability via adjusting or modulating a radius or width of the detonation chamber based on an engine condition.

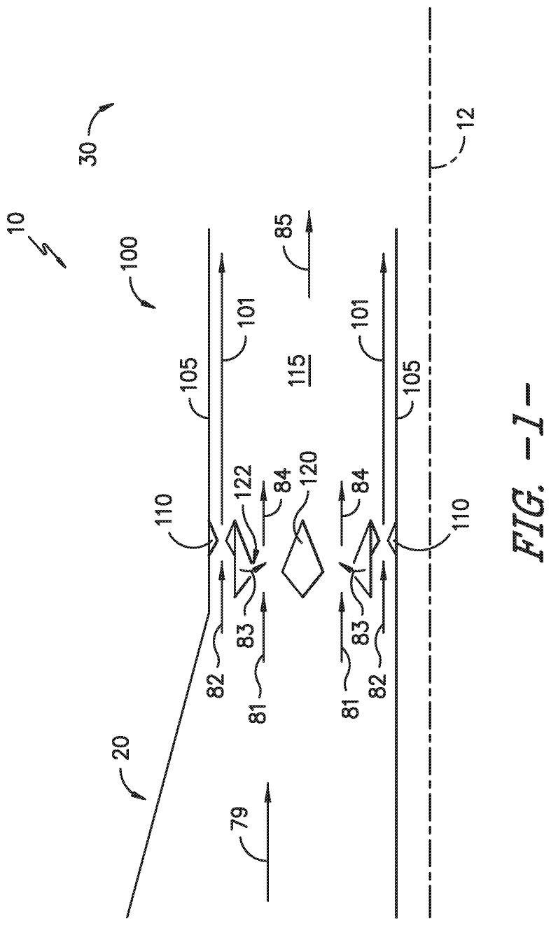

Referring now to the figures, FIG. 1 depicts a heat engine 10 (hereinafter, “engine 10”) including a rotating detonation combustion system 100 (an “RDC system”) in accordance with an exemplary embodiment of the present disclosure. The engine 10 defines an engine centerline or center plane 12 extended along a longitudinal direction L for reference purposes. The engine 10 generally includes an inlet section 20 and an expansion section 30. In one embodiment, the RDC system 100 is located downstream of the inlet section 20 and upstream of the expansion section 30, such as in serial arrangement therebetween. In various embodiments, the heat engine 10 defines a gas turbine engine, a ramjet, or other heat engine including a fuel-oxidizer burner producing combustion products that provide propulsive thrust or mechanical energy output. In an embodiment of the heat engine 10 defining a gas turbine engine, the inlet section 20 includes a compressor section defining one or more compressors generating a flow of oxidizer 79 to the RDC system 100. The inlet section 20 may generally guide a flow of the oxidizer 79 to the RDC system 100. The inlet section 20 may further compress the oxidizer 79 before it enters the RDC system 100. The inlet section 20 defining a compressor section may include one or more alternating stages of rotating compressor airfoils. In other embodiments, the inlet section 20 may generally define a decreasing cross sectional area from an upstream end to a downstream end proximate to the RDC system 100.

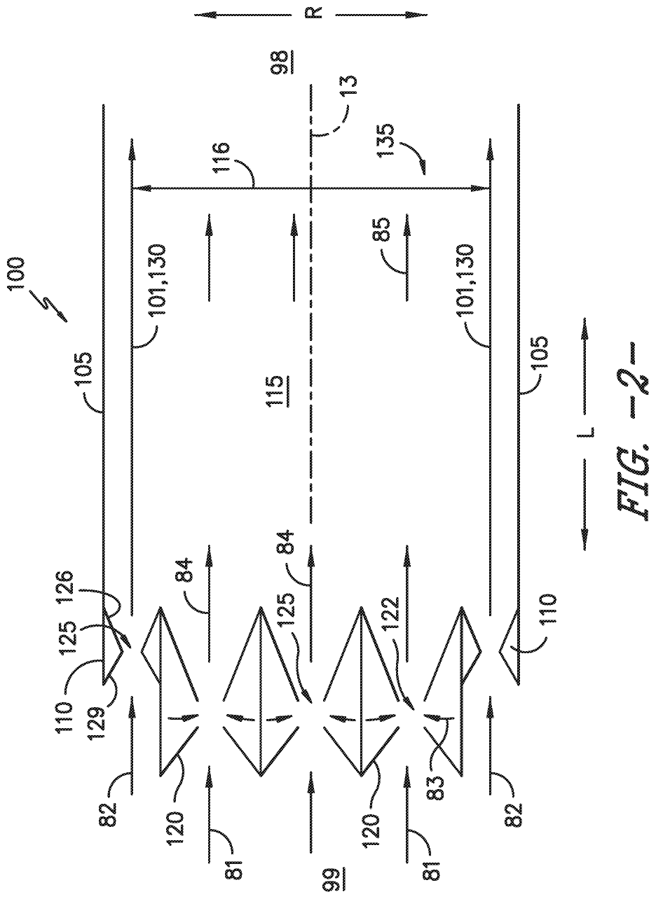

As will be discussed in further detail below, at least a portion of the flow of oxidizer 79 is mixed with a liquid or gaseous fuel 83 (or combinations thereof, or combinations of liquid fuel with a gas) and detonated to generate combustion products 85 (FIG. 2). The combustion products 85 flow downstream to the expansion section 30. In various embodiments, the expansion section 30 may generally define an open space or area, such as ambient atmosphere, or a larger radius portion relative to the RDC system 100. Expansion of the combustion products 85 generally provides thrust that propels the apparatus to which the heat engine 10 is attached, or provides mechanical energy to one or more turbines further coupled to a fan section, a generator or other electric machine, or both. Thus, the expansion section 30 may further define a turbine section of a gas turbine engine including one or more alternating rows or stages of rotating turbine airfoils. The combustion products 85 may flow from the expansion section 30 through, e.g., an exhaust nozzle to generate thrust for the heat engine 10.

As will be appreciated, in various embodiments of the heat engine 10 defining a gas turbine engine, rotation of the turbine(s) within the expansion section 30 generated by the combustion products 85 is transferred through one or more shafts or spools to drive the compressor(s) within the inlet section 20. In various embodiments, the inlet section 20 may further define a fan section, such as for a turbofan engine configuration, such as to propel oxidizer across a bypass flowpath outside of the RDC system 100 and expansion section 30.

It will be appreciated that the heat engine 10 depicted schematically in FIG. 1 is provided by way of example only. In certain exemplary embodiments, the heat engine 10 may include any suitable number of compressors within the inlet section 20, any suitable number of turbines within the expansion section 30, and further may include any number of shafts or spools appropriate for mechanically linking the compressor(s), turbine(s), and/or fans. Similarly, in other exemplary embodiments, the heat engine 10 may include any suitable fan section, with a fan thereof being driven by the expansion section 30 in any suitable manner. For example, in certain embodiments, the fan may be directly linked to a turbine within the expansion section 30, or alternatively, may be driven by a turbine within the expansion section 30 across a reduction gearbox. Additionally, the fan may be a variable pitch fan, a fixed pitch fan, a ducted fan (i.e., the heat engine 10 may include an outer nacelle surrounding the fan section), an un-ducted fan, or may have any other suitable configuration.

Moreover, it should also be appreciated that the RDC system 100 may further be incorporated into any other suitable aeronautical heat engine, such as a turboshaft engine, a turboprop engine, a turbojet engine, a ramjet engine, a scramjet engine, etc. Further, in certain embodiments, the RDC system 100 may be incorporated into a non-aeronautical heat engine, such as a land-based or marine-based power generation system. Further still, in certain embodiments, the RDC system 100 may be incorporated into any other suitable heat engine, such as a rocket or missile engine. With one or more of the latter embodiments, the heat engine may not include a compressor in the inlet section 20 or a turbine in the expansion section 30.

Referring now to FIGS. 2-5, exemplary embodiments of the RDC system 100 are generally provided. The RDC system 100 defines an upstream end 99 from which a flow of oxidizer 81 enters the RDC system 100 from the inlet section 20 (FIG. 1) and a downstream end 98 to which a burned fuel-oxidizer mixture 85 (i.e., detonation products) egresses the RDC system 100 to the expansion section 30 (FIG. 1). The RDC system 100 further defines a combustion center plane 13 around which the RDC system 100 is defined. The combustion center plane 13 is extended at least partially along a longitudinal direction L. In various embodiments, the combustion center plane 13 may be disposed at an acute angle relative to the engine centerline The RDC system 100 includes a gas nozzle 110 defining a first convergent-divergent nozzle providing a flow of gas at least partially along a longitudinal direction L. The flow of gas 101 defines a fluid wall 130 defined at least partially along the longitudinal direction L. A detonation chamber wall 105 is extended along the longitudinal direction L to define a detonation chamber 115 radially inward of the detonation chamber wall 105 relative to the combustion center plane 13. The fluid wall 130 is defined radially adjacent to the detonation chamber wall 105 (e.g., adjacent toward the combustion center plane 13). In various embodiments, such as further described herein, the detonation chamber wall 105 is defined from the radially outward-most gas nozzle 110 relative to the combustion center plane 13.

The RDC system 100 further includes a fuel-oxidizer nozzle 120 defining a second convergent-divergent nozzle providing a flow of fuel-oxidizer mixture 84 to the detonation chamber 115. The fuel-oxidizer nozzle 120 is defined radially inward of the gas nozzle 110 and upstream of the detonation chamber 115.

The gas nozzle 110 and the fuel-oxidizer nozzle 120 each define a convergent portion 129 (FIG. 2) decreasing in cross sectional area and a divergent portion 126 increasing in cross sectional area. A throat 125 is defined between the convergent portion 129 and the divergent portion 126. A fuel injection opening 122 is defined through the fuel-oxidizer nozzle 120. In various embodiments, the fuel injection opening 122 may be defined along the divergent portion 126 of the fuel-oxidizer nozzle 120. In still other embodiments, the fuel injection opening 122 may be defined approximately at the throat 125 of the convergent-divergent nozzle.

It should be appreciated that in various embodiments of the gas nozzle 110 and the fuel-oxidizer nozzle 120, the convergent-divergent structure may be configured to accelerate a flow of fluid (e.g., flow of oxidizer 81, 82) through the nozzle 110, 120. In various embodiments, the convergent-divergent structure may further define a Venturi nozzle, such as to define a choked flow of fluid (e.g., flow of oxidizer 81, 82) at the throat 125 of the nozzle 110, 120 based on an upstream pressure (e.g., at the convergent portion 129 in FIG. 2) and a downstream pressure (e.g., at the divergent portion 126 in FIG. 2).

A flow of oxidizer from the inlet section 20 (FIG. 1), shown schematically by arrows 81, passes though the fuel-oxidizer nozzle 120. The fuel injection opening 122 is defined through the fuel-oxidizer nozzle 120 to provide a flow of liquid or gaseous fuel (or combinations thereof), shown schematically by arrows 83, to mix with the flow of oxidizer 81 to produce a fuel-oxidizer mixture, shown schematically by arrows 84, at the detonation chamber 115. The fuel-oxidizer mixture 84 is then detonated in the detonation chamber 115 such as further described below.

In various embodiments, the flow of gas 101 provided by the gas nozzle 110 to define the fluid wall 130 further defines a flow of inert gas along the longitudinal direction L. As such, the flow of gas 101 defines the fluid wall 130 such as to define the detonation chamber 115 in which the fuel-oxidizer mixture 84 is detonated.

The fluid wall 130 may mitigate structural issues arising from high temperatures and thermal gradients relative to detonation chambers 115. For example, the fluid wall 130 limits or mitigates thermal interaction of detonation gases at the detonation chamber 115 with the detonation chamber wall 105, thereby mitigating structural deterioration due to the higher heat flux of pressure gain combustion systems in contrast to deflagrative combustion chambers. Additionally, or alternatively, such as further described herein, the RDC system 100 including the gas nozzle 110 providing the flow of gas 101 to produce the fluid wall 130 may further enable adjusting or modulating a radius or cross sectional area of the detonation chamber 115 based on an engine condition at the RDC system 100 and/or the engine 10.

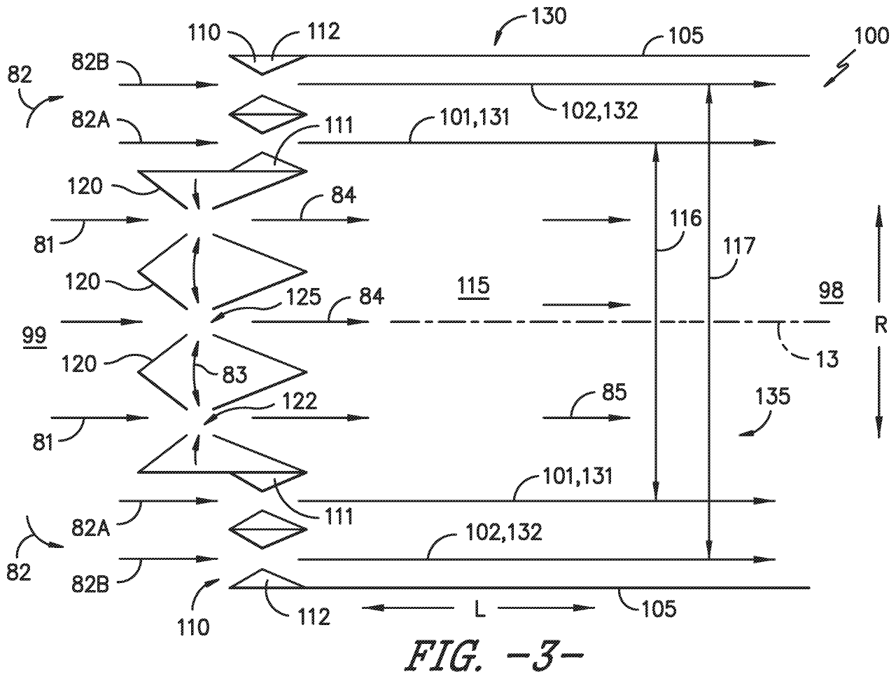

Referring now to FIG. 3, the RDC system 100 may further define a plurality of gas nozzles 110 disposed in adjacent arrangement along a radial direction R extended from the combustion center plane 13. For example, the plurality of gas nozzles 110 may define a first gas nozzle 111 and a second gas nozzle 112 disposed outward along the radial direction R from the first gas nozzle 111 relative to the combustion center plane 13. The first gas nozzle 111 provides a first flow of gas 101 to define the fluid wall 130 at a first radius 116, such as depicted at first fluid wall 131. The second gas nozzle 112 provides a second flow of gas 102 to define the fluid wall 130 at a second radius 117 different from the first radius 116, such as depicted at second fluid wall 132.

Referring briefly to FIG. 10, a method for operating a rotation detonation combustion (RDC) system is generally provided (hereinafter, “method 1000”). The method 1000 may be utilized in the engine 10 and RDC system 100 such as generally provided in regard to FIGS. 1-9. However, the method 1000 may be implemented in other RDC systems not shown in FIGS. 1-9. Additionally, steps of the method 1000 may be added, omitted, or rearranged without deviating from the scope of the disclosure.

The method 1000 includes at 1010 flowing a gas at least partially along a longitudinal direction to define a fluid wall along the longitudinal direction. For example, referring to FIGS. 1-9, the method 1000 at 1010 may include providing the flow of oxidizer 82 from the inlet section 20 of the engine 10 through the gas nozzle 110 to produce the flow of gas 101 to define the fluid wall 130 of the detonation chamber 115.

The method 1000 further includes at 1020 flowing a fuel-oxidizer mixture along the longitudinal direction radially inward of the fluid wall into the detonation chamber relative to a combustion center plane. For example, referring to FIGS. 1-9, the method 1000 at 1020 may include providing the flow of liquid or gaseous fuel 83 through the fuel injection opening 122 of the fuel-oxidizer nozzle 120 to mix with the flow of oxidizer 81 from the inlet section 20 to produce the fuel-oxidizer mixture 84 at the detonation chamber 115.

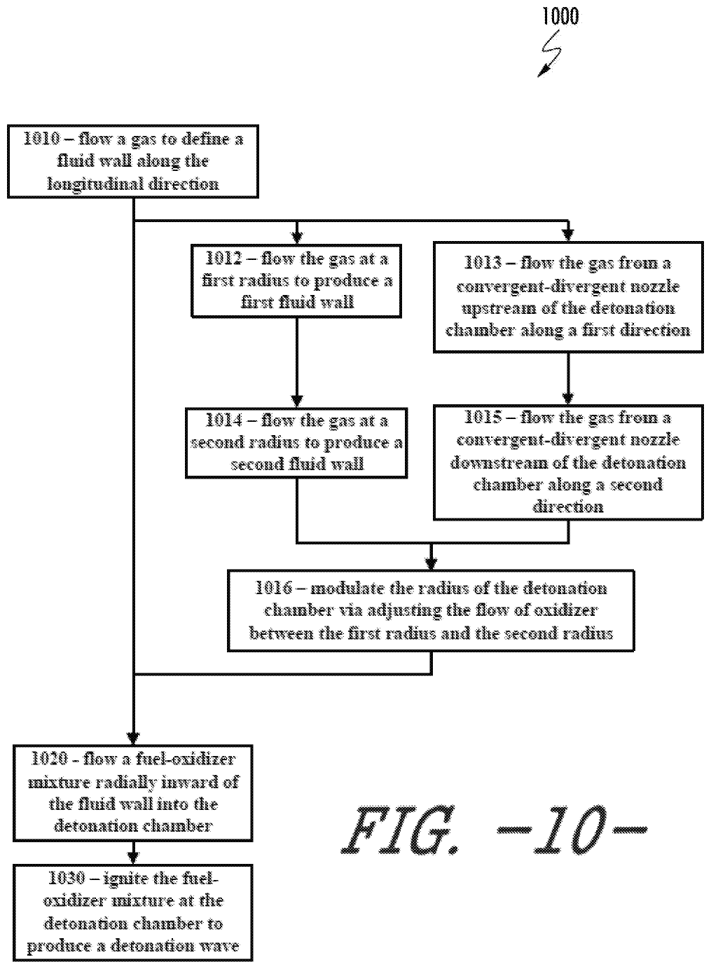

The method 1000 further includes at 1030 igniting the fuel-oxidizer mixture at the detonation chamber to produce a detonation wave radially inward of the fluid wall relative to a combustion center plane. For example, referring to FIGS. 1-9, the method 1000 at 1030 may include igniting at the detonation chamber 115 the fuel-oxidizer mixture 84 produced at 1020. As another example, the method 1000 at 1030 may include igniting the fuel-oxidizer mixture 84 to produce a detonation wave 230 within the detonation chamber 115, such as further depicted and described below in regard to FIG. 9.

Referring briefly to FIG. 9, in conjunction with FIGS. 1-8 and the method 1000 outlined in FIG. 10, a perspective view of the detonation chamber 115 (without the fuel-oxidizer nozzle 120) of the RDC system 100 is generally provided. The RDC system 100 generates a detonation wave 230 during operation. The detonation wave 230 travels in a circumferential direction C of the RDC system 100 consuming an incoming fuel-oxidizer mixture 84 and providing a high pressure region 234 within an expansion region 236 of the combustion. A burned fuel-oxidizer mixture 85 (i.e., combustion products) exits the detonation chamber 115 and is exhausted to the expansion section 30 of the engine 10 (FIG. 1).

More particularly, it will be appreciated that the RDC system 100 is of a detonation-type combustor, deriving energy from the continuous detonation wave 230. For a detonation combustor, such as the RDC system 100 disclosed herein, the combustion of the fuel-oxidizer mixture 84 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh fuel-oxidizer mixture 84, increasing such fuel-oxidizer mixture 84 above a self-ignition point. On the other side, energy released by the combustion contributes to the propagation of the detonation shockwave 230. Further, with continuous detonation, the detonation wave 230 propagates around the detonation chamber 115 in a continuous manner, operating at a relatively high frequency. Additionally, the detonation wave 230 may be such that an average pressure inside the detonation chamber 115 is higher than an average pressure within typical combustion systems (i.e., deflagration combustion systems). Accordingly, the region 234 behind the detonation wave 230 has very high pressures.

Referring to FIGS. 1-9, the RDC system 100 and production of the detonation wave 230 (FIG. 9) defines a pressure-gain combustion process. For example, the high pressure region 234 within the expansion region 236 of the detonation of the fuel-oxidizer mixture 84 produces a generally increasing pressure from the upstream end 99 to the downstream end 98 of the RDC system 100. In other embodiments, such as further described below, the fluid wall 130 may define the detonation chamber 115 of one or more radii based on the engine condition.

Referring now to FIG. 3, the plurality of gas nozzles 110 may define the first gas nozzle 111 providing the first flow of gas 101 at least partially along the longitudinal direction L at a first radius 116 from the combustion center plane 13. The first flow of gas 101 at the first radius 116 defines a first fluid wall 131 at the first radius 116. The plurality of gas nozzles 110 may further define the second gas nozzle 112 providing a second flow of gas 102 at least partially along the longitudinal direction L at a second radius 117 from the combustion center plane 13 different from the first radius 116. The second flow of gas 102 at the second radius 117 defines a second fluid wall 132 at the second radius 117.

The first gas nozzle 111 defined at the first radius 116 and the second gas nozzle 112 defined at the second radius 117 are each defined outward along the radial direction R of the fuel-oxidizer nozzle 120 relative to the combustion center plane 13. For example, the second gas nozzle 112 may be defined outward along the radial direction R from the first gas nozzle 111. The first gas nozzle 111 may further be defined outward along the radial direction R from the fuel-oxidizer nozzle 120.

The fluid wall 130 defined from the flow of gas 101 further defines a width 135 of the detonation chamber 115 along the radial direction R. In various embodiments of the RDC system 100 and method 1000 for operation, the width 135 of the detonation chamber 115 may be modulated such as to increase or decrease along the radial direction R. For example, referring to FIG. 3, the first fluid wall 131 defined from the first flow of gas 101 further defines a first width 135 of the detonation chamber 115 corresponding to the first radius 116. The second fluid wall 132 defines a second width 135 of the detonation chamber 115 corresponding to the second radius 117 different from the first width 135.

Referring back to FIG. 10, flowing the gas to define the fluid wall at 1010 may further include at 1012 flowing the gas at least partially along the longitudinal direction at a first radius from the combustion center plane to produce a first fluid wall. For example, referring to FIGS. 1-9, the method 1000 at 1012 may include producing the first fluid wall 131 at the first radius 116 via the first flow of gas 101 through the first gas nozzle 111.

Referring back to FIG. 10, flowing the gas to define the fluid wall at 1010 may further include at 1014 flowing the gas at least partially along the longitudinal direction at a second radius from the combustion center plane different from the first radius to produce a second fluid wall. For example, referring to FIGS. 1-9, the method 1000 at 1014 may include producing the second fluid wall 132 at the second radius 117 via the second flow of gas 102 through the second gas nozzle 112.

The method 1000 may further include at 1016 modulating the radius or width of the detonation chamber via adjusting the flow of oxidizer between the first radius and the second radius to adjust the width of the detonation chamber. For example, referring to FIG. 3, modulating the flow of oxidizer 82 between the first radius 116 and the second radius 117 may include selectively directing the flow of oxidizer 82 between the first gas nozzle 111 and the second gas nozzle 112.

As another example, selectively directing the flow of oxidizer 82 between the first gas nozzle 111 and the second gas nozzle 112 may include selectively directing a portion of the flow of oxidizer 82 to the first gas nozzle 111, such as depicted by arrows 82A, and directing a portion of the flow of oxidizer 82 to the second gas nozzle 112, such as depicted by arrows 82B.

Selectively directing the portions of the flow of oxidizer 82, 82A, 82B may include decreasing a first portion of the flow of oxidizer 82 (e.g., flow of oxidizer 82A) and increasing a second portion of the flow of oxidizer 82 (e.g., flow of oxidizer 82B). Selectively directing the portions of the flow of oxidizer 82, 82A, 82B may further include increasing the first portion of the flow of oxidizer 82 (e.g., flow of oxidizer 82A) and decreasing the second portion of the flow of oxidizer 82 (e.g., flow of oxidizer 82B).

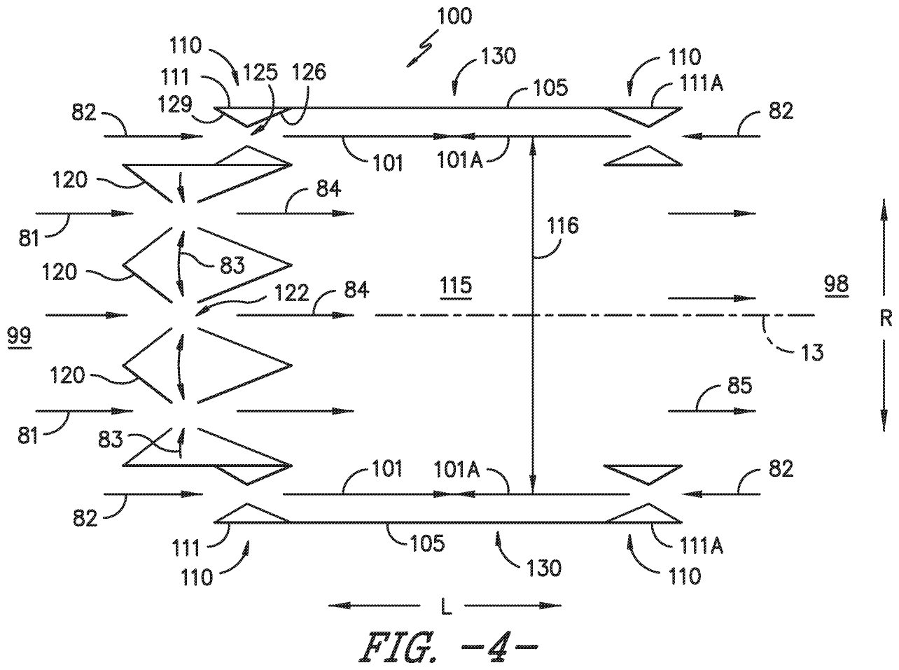

Referring still to the method 1000, the RDC system 100, and the engine 10, flowing the gas (e.g., first flow of gas 101) to generate the first fluid wall (e.g., first fluid wall 131) is at one or more of a first engine condition. Furthermore, flowing the gas (e.g., second flow of gas 102) to generate the second fluid wall (e.g., second fluid wall 112) is at one or more of a second engine condition different from the first engine condition. In various embodiments, each engine condition defines one or more of a pressure, temperature, or flow rate of oxidizer 81, 82 upstream of the detonation chamber 115 (e.g., at the inlet section 20 in FIG. 1, at the convergent portion 129 of one or more nozzles 110, 120, etc. in FIGS. 2 and 4), or one or more of a pressure, temperature, or flow rate of fuel 83 provided to the detonation chamber 115, or combinations thereof. For example, the engine condition may correspond to a startup or low power condition (e.g., from zero thrust or power to a minimum steady state fuel and oxidizer flow condition), a high power condition (e.g., a maximum thrust or power output, or maximum fuel and/or oxidizer flow condition), or one or more mid-power conditions between the low power condition and the high power condition.

In various embodiments, the flow of oxidizer 82 is selectively directed to the first gas nozzle 111 or the second gas nozzle 112 corresponding to a desired width 135 (FIG. 9), or alternatively, the desired first radius 116 or second radius 117, further based on the engine condition.

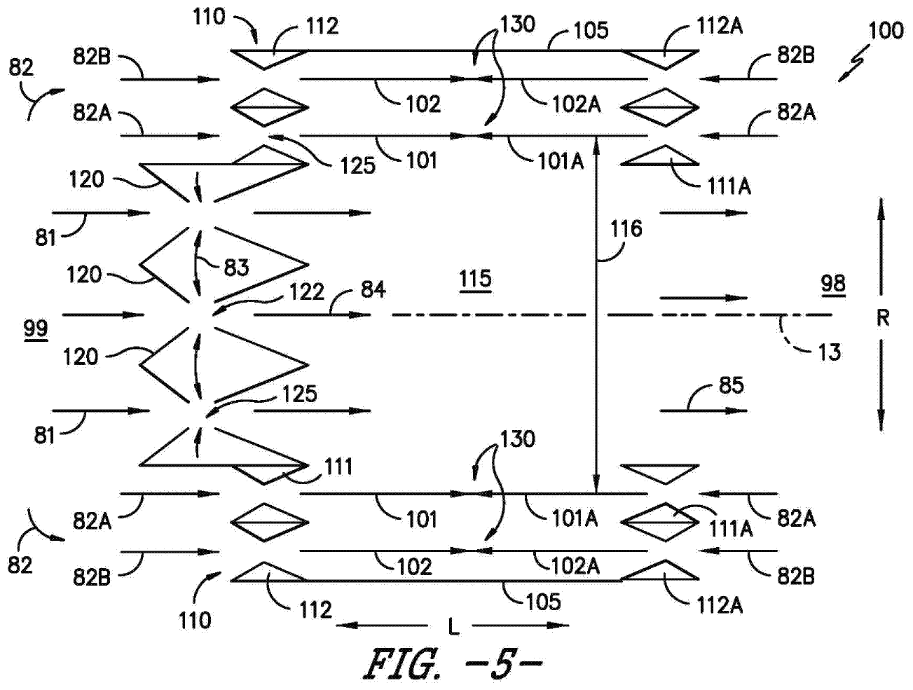

Referring now to FIGS. 4-5, further embodiments of the RDC system 100 are further provided. The exemplary embodiments provided in regard to FIG. 4-5 generally include the elements or configurations shown and described in regard to FIGS. 1-3. Regarding FIGS. 4-5, the gas nozzles 110 of the RDC system 100 may further define the first gas nozzle 111 defined upstream of the detonation chamber 115. The first gas nozzle 111 provides the first flow of gas 101 along a first direction at least partially along the longitudinal direction L (e.g., toward the downstream end 98). The gas nozzles 110 further define an opposing first gas nozzle 111A defined downstream of the of the first gas nozzle 111 along the longitudinal direction L. In one embodiment, the opposing first gas nozzle 111A is disposed downstream of the detonation chamber 115. The opposing first gas nozzle 111A provides an opposing first flow of gas 101A along a second direction (e.g., toward the upstream end 99) at least partially along the longitudinal direction L opposite of the first direction. The first gas nozzle 111 and the opposing first gas nozzle 111A may together define the fluid wall 130 substantially along the longitudinal direction L. In various embodiments, the first gas nozzle 111 and the opposing first gas nozzle 111A are disposed at approximately the same first radius 116 and separated along the longitudinal direction L.

Referring now to FIG. 5, the exemplary embodiment of the RDC system 100 may further include the second gas nozzle 112 disposed outward along the radial direction R of the first gas nozzle 111 relative to the combustion center plane 13. The second gas nozzle 112 provides the second flow of gas 102 along a first direction at least partially along the longitudinal direction L (e.g., toward the downstream end 98). The gas nozzles 110 further define an opposing second gas nozzle 112A defined downstream of the of the second gas nozzle 112 along the longitudinal direction L. In one embodiment, the opposing second gas nozzle 112A is disposed downstream of the detonation chamber 115. The opposing second gas nozzle 112A provides an opposing second flow of gas 102A along a second direction (e.g., toward the upstream end 99) at least partially along the longitudinal direction L opposite of the first direction. The second gas nozzle 112 and the opposing second gas nozzle 112A may together define the fluid wall 130, such as the second fluid wall 132, substantially along the longitudinal direction L. In various embodiments, the second gas nozzle 112 and the opposing second gas nozzle 112A are disposed at approximately the same second radius 117 and separated along the longitudinal direction L. The second fluid wall 132 defined by the flows of gas 102, 102A may generally be defined outward along the radial direction R relative to the combustion center plane 13 of the first fluid wall 131 defined by the flows of gas 101, 101A from the first gas nozzle 111 and opposing first gas nozzle 111A.

Referring back to FIG. 10, in conjunction with FIGS. 4-5, the method 1000 at 1010 may further include at 1013 flowing the gas from a convergent-divergent nozzle upstream of the detonation chamber (e.g., first gas nozzle 111, second gas nozzle 112) along a first direction at least partially along the longitudinal direction; and at 1015 flowing the gas from a convergent-divergent nozzle downstream of the detonation chamber (e.g., opposing first gas nozzle 111A, opposing second gas nozzle 112A) along a second direction at least partially along the longitudinal direction opposite of the first direction. In one embodiment, the method 1000 at 1013 and 1015 may further include flowing the gas from a convergent-divergent nozzle downstream of the detonation chamber along a second direction is at least partially along a radial plane approximately equal to a radial plane of the convergent-divergent nozzle upstream of the detonation chamber.

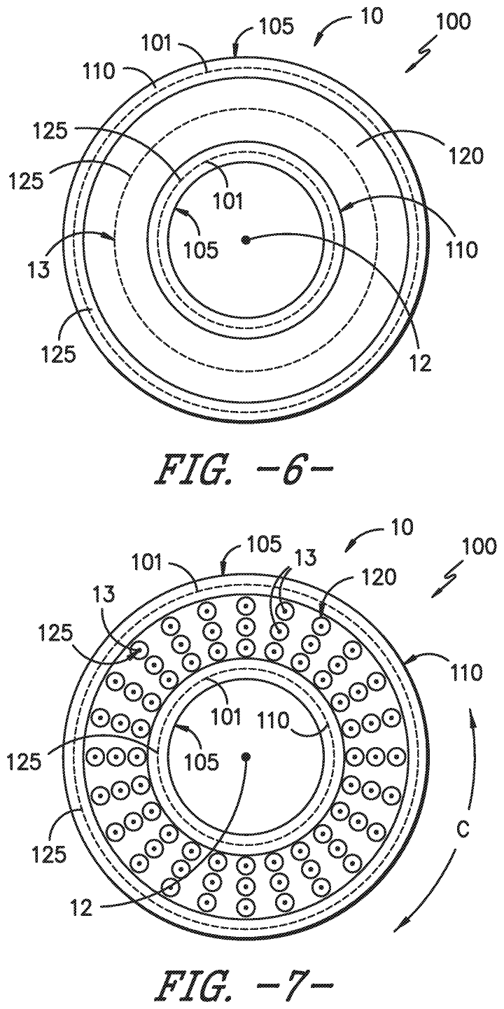

Referring now to FIGS. 6-8, exemplary circumferential views of the RDC system 100 according to various embodiments shown and described in regard to FIGS. 1-5 are generally provided. In various embodiments, the fuel-oxidizer nozzle 120 may be defined annularly around the engine centerline 12, such as generally provided in regard to FIG. 6. For example, the throat 125 of the fuel-oxidizer nozzle 120 is defined annularly around the engine centerline 12.

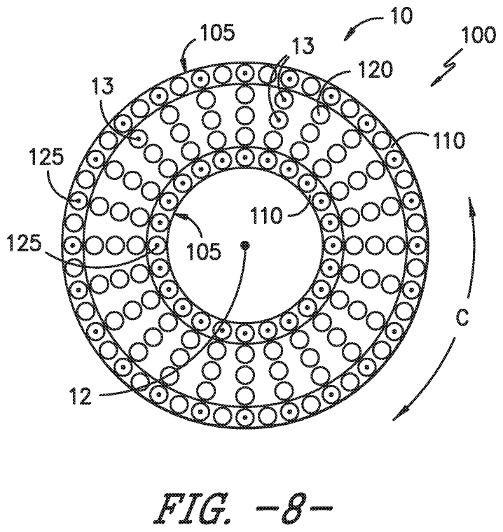

In still various embodiments, such as generally provided in regard to FIGS. 6-7, the gas nozzle 110 may be defined annularly around the engine centerline 12. The throat 125 of the gas nozzle 110 is defined annularly around the engine centerline 12.

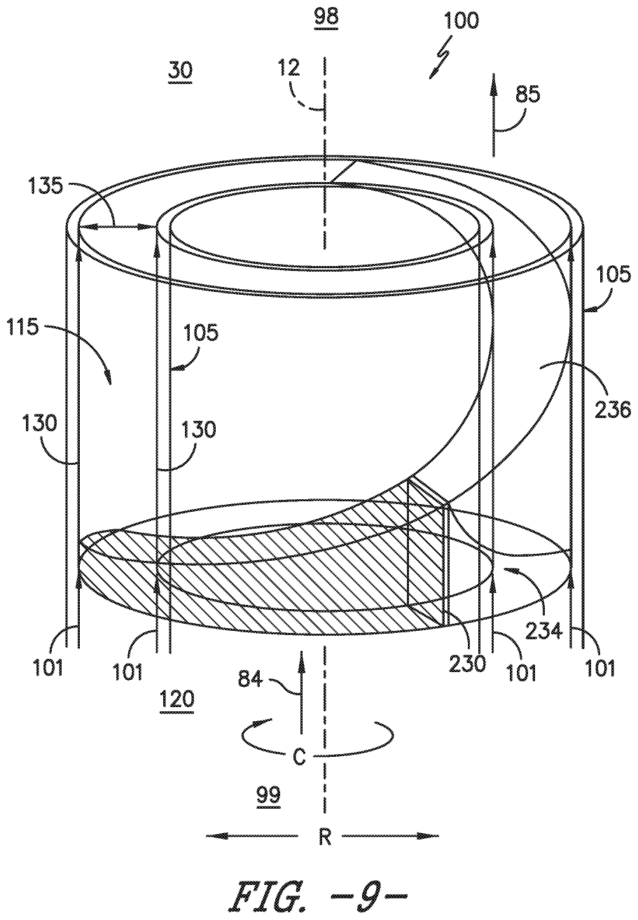

In still yet various embodiments, such as generally provided in regard to FIGS. 7-8, the RDC system 100 defines a plurality of fuel-oxidizer nozzles 120 disposed in adjacent arrangement along circumferential direction C. For example, the throat 125 of each fuel-oxidizer nozzle 120 is defined generally concentric within each fuel-oxidizer nozzle 120, such as around the combustion center plane 13 extended through the fuel-oxidizer nozzle 120.

In still various embodiments, such as generally provided in regard to FIG. 8, the RDC system 100 defines a plurality of gas nozzles 110 disposed in adjacent arrangement along the circumferential direction C. For example, the throat 125 of each gas nozzle 110 is defined generally concentric within each gas nozzle 110, such as around the combustor centerline 13 extended through the gas nozzle 110.

Although the RDC system 100 describes the first gas nozzle 111 and the second gas nozzle 112 each disposed at the first radius 116 and the second radius 117, respectively, and each producing a corresponding first fluid wall 131 and second fluid wall 132, respectively, it should be appreciated that the RDC system 100 may include a plurality of gas nozzles 110 in adjacent arrangement along the radial direction R such as to define a third gas nozzle, a fourth gas nozzle, etc., to an Nth gas nozzle, each disposed at a third radius, a fourth radius, etc. to an Nth radius, respectively, each producing a corresponding third fluid wall, fourth fluid wall, etc. to an Nth fluid wall. In various embodiments, the plurality of radii at which the gas nozzle 110 may be disposed corresponds, at least in part, to a desired quantity of detonation cells or width 135 of the detonation chamber 115 based on a desired engine condition of the engine 10.

Embodiments of the engine 10 and RDC system 100 shown and described herein, or portions or elements thereof shown and described herein, may be part of a single, unitary component and may be manufactured from any number of processes commonly known by one skilled in the art. These manufacturing processes include, but are not limited to, those referred to as “additive manufacturing” or “3D printing”. Additionally, or alternatively, any number of forging, casting, machining, welding, brazing, or sintering processes, or any combination thereof may be utilized to construct the engine 10 or RDC system 100 and the elements shown and described herein. Furthermore, the engine 10 or RDC system 100 may constitute one or more individual components that are mechanically joined (e.g. by use of bolts, nuts, rivets, or screws, or welding or brazing processes, or combinations thereof) or are positioned in space to achieve substantially similar geometric results as if manufactured or assembled as one or more components. Non-limiting examples of suitable materials include nickel and cobalt-based materials and alloys, iron or steel based materials and alloys, titanium-based materials and alloys, aluminum-based materials and alloys, composite materials, or combinations thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotating detonation combustion (RDC) system, the RDC system comprising:
a gas nozzle defining a first convergent-divergent nozzle providing a flow of gas at least partially along a longitudinal direction, wherein the flow of gas defines a fluid wall defined at least partially along the longitudinal direction, and wherein the fluid wall defines a detonation chamber radially inward relative to a combustion center plane;
a fuel-oxidizer nozzle defining a second convergent-divergent nozzle providing a flow of fuel-oxidizer mixture to the detonation chamber, wherein the fuel-oxidizer nozzle is defined radially inward of the gas nozzle and upstream of the detonation chamber relative to the combustion center plane.

2. The RDC system of claim 1, wherein the flow of gas provided by the gas nozzle defines a flow of inert gas along the longitudinal direction defining the detonation chamber.

3. The RDC system of claim 1, wherein the gas nozzle is defined annularly around the combustion center plane.

4. The RDC system of claim 1, wherein the fuel-oxidizer nozzle is defined annularly around the combustion center plane.

5. The RDC system of claim 1, wherein the RDC system comprises a plurality of the fuel-oxidizer nozzle disposed in an adjacent arrangement around a circumferential direction around the combustion center plane.

6. The RDC system of claim 1, wherein the RDC system comprises a plurality of the gas nozzle disposed in an adjacent arrangement around a circumferential direction around the combustion center plane.

7. The RDC system of claim 1, wherein the RDC system comprises:
a first gas nozzle defined upstream of the detonation chamber providing a first flow of gas at least partially along a first direction; and
an opposing first gas nozzle defined downstream of the first gas nozzle providing an opposing first flow of gas along a second direction at least partially along the longitudinal direction opposite of the first direction.

8. The RDC system of claim 1, wherein the RDC system comprises:
a first gas nozzle providing a first flow of gas at least partially along the longitudinal direction at a first radius from the combustion center plane to define a first fluid wall; and
a second gas nozzle providing a second flow of gas at least partially along the longitudinal direction at a second radius from the combustion center plane different from the first radius to define a second fluid wall.

9. The RDC system of claim 8, wherein the first gas nozzle is defined at the first radius and the second gas nozzle is defined at the second radius, and wherein each of the first gas nozzle and the second gas nozzle are defined radially outward of the fuel-oxidizer nozzle relative to the combustion center plane.

10. The RDC system of claim 9, wherein the first fluid wall defines a first radius of the detonation chamber and the second fluid wall defines a second radius of the detonation chamber different from the first radius.

11. A method for operating a rotation detonation combustion (RDC) system, the method comprising:
flowing a gas at least partially along a longitudinal direction to define a fluid wall along the longitudinal direction;
flowing a fuel-oxidizer mixture along the longitudinal direction radially inward of the fluid wall into the detonation chamber relative to a combustion center plane; and
igniting the fuel-oxidizer mixture at the detonation chamber to produce a detonation wave radially inward of the fluid wall relative to the combustion center plane.

12. The method of claim 11, wherein flowing the gas is along a detonation chamber wall within the detonation chamber.

13. The method of claim 12, wherein flowing the gas at least partially along the longitudinal direction further comprises:
flowing the gas from a convergent-divergent nozzle upstream of the detonation chamber along a first direction at least partially along the longitudinal direction.

14. The method of claim 13, wherein flowing the gas at least partially along the longitudinal direction further comprises:
flowing the gas from a convergent-divergent nozzle downstream of the detonation chamber along a second direction at least partially along the longitudinal direction opposite of the first direction.

15. The method of claim 11, further comprising:
modulating a radius of the detonation chamber via the flow of gas at a first radius or a second radius.

16. The method of claim 15, wherein modulating the radius via the flow of gas includes selectively directing the flow of gas between a first gas nozzle at the first radius and a second gas nozzle at the second radius.

17. The method of claim 12, wherein flowing a gas at least partially along a longitudinal direction to define a fluid wall further comprises:
flowing the gas at least partially along the longitudinal direction at a first radius from the combustion center plane to produce a first fluid wall; and
flowing the gas at least partially along the longitudinal direction at a second radius from the combustion center plane different from the first radius to produce a second fluid wall.

18. The method of claim 17, wherein flowing the gas to generate the first fluid wall is at one or more of a first engine condition, and wherein flowing the gas to generate the second fluid wall is at one or more of a second engine condition different from the first engine condition.

19. The method of claim 18, wherein each engine condition defines one or more of a pressure, temperature, or flow rate of gas upstream of the detonation chamber, or one or more of a pressure, temperature, or flow rate of fuel upstream of the detonation chamber, or combinations thereof.

20. The method of claim 17, wherein flowing the gas at the first radius to produce the first fluid wall defines a first radius of the detonation chamber different from flowing the gas at the second radius to produce the second fluid wall defining a second radius of the detonation chamber different from the first radius.
